(19) United States
(12) Patent Application Publication
(10) Pub. No.: US 2005/0065058 A1
(43) Pub. Date: Mar. 24, 2005

(54) Compositions for treating shoes and methods and articles employing same

(75) Inventors: Brian Joseph Roselle, Fairfield, OH (US); Freddy Arthur Barnabas, West Chester, OH (US); Gregory Bruce Huntington, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/862,706

(22) Filed: Jun. 7, 2004

Related U.S. Application Data
(60) Provisional application No. 60/478,331, filed on Jun. 13, 2003.

(51) Int. Cl. C11D 3/37

(52) U.S. Cl. 510/475

(57) ABSTRACT

A “two-in-one” treating system, composition, method, composition of matter, and article of manufacture for treating shoes, especially leather-containing shoes, such as athletic shoes, is provided. More particularly, the present invention relates to “two-in-one” treating systems and/or compositions that impart a desired benefit, such as cleaning and conditioning, prior to, during, and/or after washing the shoes.

### CROSS REFERENCE TO RELATED APPLICATION

This application claims the benefit of the filing date of U.S. Provisional Patent Application No. 60/478,331, filed Jun. 13, 2003, the disclosure of which is incorporated by reference herein.

### FIELD OF THE INVENTION

The present invention relates to compositions, methods, compositions of matter, and articles of manufacture for treating shoes, especially leather-containing shoes, such as athletic shoes. More particularly, the present invention relates to “two-in-one” treating systems and/or compositions that impart a desired benefit, such as cleaning and conditioning, prior to, during, and/or after washing the shoes.

### BACKGROUND OF THE INVENTION

Soiled and/or stained shoes, especially athletic shoes, have been a problem since the advent of shoes. Traditional attempts at cleaning soiled or stained shoes have included washing the soiled shoes manually in wash basins or sinks, with a conventional garden hose, clapping the shoes together to attempt to dislodge clay, mud and other dirt fixed to the shoes, or using a conventional washing machine with or without detergent being added. However, consumers have encountered less than satisfactory cleaning results by these conventional methods. Further, consumers have witnessed damage to shoes, especially when washing the shoes in a conventional washing machine with conventional, high pH detergents. Examples of damage include, loss of stability, softness, suppleness, and/or flexibility.

Shoe cleaning represents a significant and largely unmet consumer need, especially for shoes that contain canvas, nylon, mesh, synthetic leather, and/or natural leather surfaces, and particularly leather-containing shoes, such as athletic shoes with ground-in soil. Athletic shoes are worn not just for athletic use but also for casual use, both indoors and outdoors. The outdoor and athletic use of these shoes can lead to significant soiling problems. For instance, dirt, mud, and clay soils may soil shoes when worn outdoors for either athletic or casual use. Similarly, grass stains and soils may also soil these shoes under similar circumstances. A particular problem for cleaning shoes is that unlike many “dress” or formal shoes, the outer parts of athletic shoes may often include leather, fabrics, or combinations of the two, and may be very porous to soil. Most formal shoes have a glossy smooth outside surface and are generally not as heavily soiled as athletic shoes often are. Thus, for cleaning purposes under most circumstances, formal shoes may simply require wiping with a damp cloth. Unlike formal shoes, athletic shoes are often more heavily soiled. Shoe soil on athletic shoes is often more difficult to remove because of the many types of athletic shoe outer coverings. In particular, it is difficult to simply wipe off soil collected on the fabric parts of athletic shoes. Similarly, the soil collected on rough or uneven plastic, synthetic, or rubber surfaces found on the bottom portions of shoe is also often difficult to remove, as well. As such, it is highly desirable to find a better method for cleaning athletic shoes.

Further, while not wishing to be bound by theory, it is believed that the conventional washing of shoes in water or detergent-containing water has deleterious effects on the shoe surfaces, especially leather-containing shoes because, among other reasons, as leather ages it often stiffens, but especially resulting from the loss of fat liquors, oils, or tanning agents, such as, chromium, from exposure to conventional washing techniques.

While some detergent compositions designed to wash soiled shoes in a washing machine are known, these typically employ various types of unmodified polyacrylic acids/polyacrylates to achieve cleaning and soil dispersion and require a separate, additional conditioning agent to achieve acceptable shoe conditioning results. The use of unmodified polyacrylates, as cleaners, can contribute to stiffening, especially in leather-containing materials, and, further places a limitation on the type of additional cleaning benefit agents that can be incorporated in such products as product stability issues may arise. For example, surfactants, particularly anionic surfactants that are not typically compatible with these polyacrylate compositions, have to be minimized, left out of the formula, or used separately in a pre- or post-treatment composition.

Accordingly, when washing the shoes in a conventional washing machine with conventional, high pH detergents, there is a need for cheaper, more convenient, and improved compositions and methods employing the same, to treat shoes without damage. It has been surprisingly found that the use of a single hydrophobically modified polyacrylic polymer (HMPAP) can provide two benefits in one-shoe cleaning and conditioning. By substituting HMPAP for both the unmodified polyacrylic acid/polyacrylate cleaning agents, and the separate, additional conditioning agents required in conventional shoe cleaning compositions, this “two-in-one” treating composition reduces manufacturing and formulation costs. Furthermore, with the use of HMPAP, there is an improvement in product stability, which in turn allows for more robust formulations and better performance.

The object of this invention is to achieve multiple benefits by formulation of a single product, for example, a “two-in-one” shoe treatment product comprising HMPAP and at least one benefit agent. This “two-in-one” shoe treatment product may effectively deliver multiple benefits, such as both as a cleaning agent and conditioning agent, especially when used during either the first wash cycle or subsequent wash cycles of a washing machine.

### SUMMARY OF THE INVENTION

The present invention relates to “two-in-one” treating systems, compositions, and methods for treating one or more shoes having an interior and an exterior surface in need of treatment, especially for shoes that contain canvas, nylon, mesh, synthetic leather, and/or natural leather surfaces, and particularly leather-containing shoes, such as, athletic shoes.

In accordance with one aspect of the present invention, a “two-in-one” treating composition and method for treating shoes are provided. The “two-in-one” treating composition comprises: (a) a hydrophobically modified polyacrylic acid; and (b) optionally, one or more additional benefit agents. The method comprising the steps of: (a) providing an effective amount of a two-in-one treating composition described herein; and (b) contacting one or more shoes in need of treatment with the two-in-one treating composition in an aqueous medium for an effective amount of time so that the contact provides one or more of the following desired benefits to the one or more shoe surfaces: cleaning, conditioning, softening, brightening, disinfecting, and deodorizing.

In accordance with another aspect of the present invention, a “two-in-one” treating system for treating shoes is provided. The “two-in-one” treating system comprises: (a) a “two-in-one” treating composition comprising: (i) a hydrophobically modified polyacrylic acid; and (ii) optionally, one or more additional benefit agents; and (b) a flexible container.

In accordance with another aspect of the present invention, an article of manufacture comprising a kit is provided. The kit comprises: (a) a package; (b) the “two-in-one” treating composition described above; (c) a flexible container; and (d) instructions for using the “two-in-one” treating composition and/or the flexible container to treat one or more shoes.

In accordance with another aspect of the present invention, a composition of matter is provided. The composition of mater comprises wash and/or rinse water in an automatic washing machine, wherein the wash and/or rinse water comprises from about 2 ppm to about 100,000 ppm, by concentration, of a hydrophobically modified polyacrylic acid, and optionally, one or more additional benefit agents, delivered via an automatic washing detergent composition.

### DETAILED DESCRIPTION OF THE INVENTION

Definitions

The phrase “aqueous medium” herein is meant to encompass any amount of wash water and/or rinse water in an automatic washing machine, sink water, hose water, rain, river and/or lake water, and combinations thereof.

The phrase “two-in-one treating composition” herein is meant to encompass a hydrophobically modified polyacrylic acid, and optionally, one or more additional benefit agents.

The phrase “two-in-one” treating system herein is meant to encompass generally a hydrophobically modified polyacrylic acid, optionally, one or more additional benefit agents, and a flexible container.

The phrase “two-in-one shoe treatment product” herein is meant to encompass generally the “two-in-one” treating system and/or composition as an article of manufacture.

The term “HMPAP” herein is meant to encompass any suitable hydrophobically modified polymer or copolymer containing at least one of the following: polyacrylic acid monomer, modified polyacrylic acid monomer, poly-methacrylic acid monomer, modified poly-methacrylic acid monomer, poly-alpha-chloroacrylic acid monomer, modified poly-alpha-chloroacrylic acid monomer, poly-alpha-hydroxyacrylic acid monomer, or modified poly-alpha-hydroxyacrylic acid monomer.

The term “effective amount” is an amount that is capable of providing at least one desired benefit to the article, such as a shoe or any portion thereof, including, but not limited to: any canvas, nylon, mesh, synthetic leather, and/or natural leather surface thereof, being treated. An effective amount of a benefit agent is any amount capable of imparting the benefit associated with the benefit agent to the article.

“Pre-treat” herein is meant to encompass any application of a “two-in-one” treating composition and/or any other suitable pre-treating composition to one or more shoes prior to washing the one or more shoes.

“Through-the-wash” herein is meant to encompass any application of a “two-in-one” treating composition and/or any other suitable through-the-wash treating composition (e.g. a suitable heavy-duty liquid detergent) to one or more shoes during washing of the one or more shoes.

“Post-treat” herein is meant to encompass any application of a “two-in-one” treating composition and/or a suitable post-treating composition to one or more shoes after washing the one or more shoes.

“Benefit agent” herein is meant to encompass any agent that can impart a consumer recognizable and/or measurable benefit to an article, such as a shoe. Examples of such benefit agents includes, but are not limited to, additional cleaning agents, additional conditioning agents, disinfecting agents, perfumes, brighteners, release agents, especially soil release agents, enzymes, water-proofing agents, odor control agents, and mixtures thereof.

“Shoe(s)” herein is meant to encompass the entire shoe, any portion thereof, and includes any and all surfaces (e.g. interior and exterior).

“Conditioning Agent” is meant to encompass any and all compositions that mitigate shoe material stiffening and/or hardening in materials, such as, leather, canvas, rubber, plastic, and fabrics.

“Washing” herein is meant to encompass any means of contacting a shoe with an aqueous medium. Examples of types of washing include, but are not limited to: placing or submerging (at least partially or completely) the shoe in a washtub or other receptacle, such as a sink or a pan; spraying the shoe with water from a garden hose or by some other means of delivering water, such as a faucet; allowing rain drops to contact the shoe; placing or submerging (at least partially or completely) the shoe in a body of water, such as a river, lake or pond; placing or submerging (at least partially or completely) the shoe in an aqueous wash solution contained within a conventional automatic washing machine (such as, wash water and/or rinse water); and/or alternatively placing or submerging (at least partially or completely) the shoe in the wash water during the wash cycle, and optionally in the rinse water during the rinse cycle.

“Desired Benefits” include, but are not limited to, cleaning, conditioning, softening, brightening, disinfecting, deodorizing, preserving, waterproofing, whitening, dying, and prolonging usage and comfort.

Treating System and/or Composition

When treating shoes, it is highly desirable to both clean and condition with a single product, such as with the “two-in-one” treating system and/or composition disclosed herein. It is envisioned that this may be done through a variety of means within the scope of this disclosure. Without wishing to be bound by theory, it is believed that with the addition of sufficiently hydrophobic moieties to the polycarboxylate polymeric chain, the HMPAP can both clean and condition soiled shoes. It is further believed that an HMPAP can promote soil dispersion from surfaces via the polymerized carboxylate; while at the same time can provide conditioning benefits by having some of the polycarboxylate complex with collagen. In addition, its hydrophobic moiety can help to lubricate the surface being treated. Previously, it was believed that such formulas would be subject to stability problems associated with compositions comprising an isotropic mixture of high levels of both carboxylate polymers and surfactants.

The “two-in-one” treating systems and/or compositions herein can comprise any suitable HMPAP in any suitable amount. In one embodiment, an HMPAP is provided in an amount from about 0.001% to about 99.99% by weight, or from about 0.01% to about 80%, or alternatively from about 0.05% to about 70% by weight of the composition. The HMPAP and optional, one or more benefit agents, may be present in an aqueous medium as a composition of matter in an amount ranging from about 2 ppm to about 100,000 ppm, or alternatively from about 10 ppm to about 25,000 ppm. Suitable HMPAPs include, but are not limited to, those commercially available under the tradenames ALCOSPERSE® 725 (35% active), ALCOSPERSE® 747-D (powder) from Alco Chemical, and LUBRITAN® AS from the Rohm and Haas Company.

Benefit Agents

The “two-in-one” treating systems and/or compositions may comprise an effective amount of HMPAP acting in concert with any suitable benefit agent. Any suitable benefit agent in any suitable amount can be used in the “two-in-one” treating systems and/or compositions. The benefit agent(s) may be present in the “two-in-one” treating system and/or composition in an amount from 0% to about 99.999%, or from about 0.001% to about 90%, or from about 0.1% to about 80%, or from about 0.1% to about 70%, or from about 0.1% to about 60%, or from about 0.1% to about 50%, or from about 0.1% to about 40%, or from about 0.1% to about 30%, or from about 0.1% to about 20%, or from about 0.1% to about 10%, or alternatively from about 0.5% to about 5% by weight of the composition. The benefit agent may also be present in an aqueous medium in an amount ranging from about 2 ppm to about 100,000 ppm, or alternatively from about 10 ppm to about 25,000 ppm.

In one embodiment, the “two-in-one” treating systems and/or compositions may comprise one or more of the following benefit agents: soil release/removal agents, surfactants, calcium/magnesium removal agents, or pH modifiers (especially alkaline pH modifiers). Any suitable soil release/removal agent in any suitable amount can be used. Suitable soil release/removal agents include, but are not limited to: hydrophilic dispersants, hydrophobic dispersants, oligomeric hydrophobic dispersants, and combinations thereof. Suitable examples include, but are not limited to: ethoxylated or alkoxylated polyalkyleneimines, polyalkyleneoxy substituted and unsubstituted polyalkyleneimine dispersants, polyaspartic acid and its salt dispersants, aryl sulphonic acid/formaldehyde condensate dispersants, and combinations thereof. The “two-in-one” treating systems and/or compositions of some non-limiting embodiments can comprise from about 0.05% to about 20%, or about 0.1% to about 15%, or alternatively from about 0.1% to about 10% by weight of the composition of soil release/removal agent. Examples of such dispersants are generally described in U.S. Pat. Nos. 5,565,145; 4,597,898; 5,858,948; and 6,121,226.

Any suitable surfactant in any suitable amount can be used. Suitable surfactants include: anionic, nonionic, cationic, zwitterionic, amphophilic surfactants, and mixtures thereof. For example, a suitable nonionic surfactant may comprise at least some C₈-C₁₈ alkyl ethoxylate, with an average degree of ethoxylation from about 5 to about 15 moles of ethylene oxide per mole of alcohol. Suitable nonionic surfactants may be commercially available under the tradename NEODOL® 23-9 from Shell Chemical Company and alkyl glycoside produced by Cognis Corporation under the trade name GLUCOPON® (50% active). The “two-in-one” treating systems and/or compositions of some non-limiting embodiments can comprise from about 1% to about 80%, or from about 1% to about 50%, or from about 1% to about 30%, or alternatively from about 1% to about 15% by weight of the composition of a surfactant.

Any suitable calcium/magnesium removal agent in any suitable amount can be used. Suitable calcium/magnesium removal agents include, but are not limited to: unmodified polyacrylates, salts of polyacrylic acids, acrylate/maleate copolymers, salts of acrylate/maleic acid, and mixtures thereof. However, the use of some unmodified polyacrylate acids/polyacrylates in the “two-in-one” treating system and/or composition tends to stiffen shoe materials and negate the softening affects from the conditioning benefit of HMPAP. In one non-limiting embodiment, the “two-in-one” treating system and/or composition can be substantially free of unmodified polyacrylate acids/polyacrylates.

Any suitable pH modifiers may be used in any suitable amount. Examples of suitable pH modifiers include, but are not limited to: water soluble buffers, alkali phosphates, carbonates, silicates, and mixtures thereof. In addition, techniques for controlling pH may also include the use of suitable acids, as well as, other well-known alkaline buffers and alkalis in any suitable amount or form.

The “two-in-one” treating systems and/or compositions may also include other suitable benefit agents or detergent adjuncts including, but not limited to: brighteners, thickeners, heavy metal chelating agents, suds suppressors, chemical stabilizers (including antioxidants), silicones, antimicrobial actives and/or preservatives, bleaches (particularly for canvas shoes), bleach activators, bleach catalysts, enzymes, enzyme stabilizing systems, hydrotropes, opacifiers, antioxidants, perfumes, dyes, carriers, speckles, and mixtures thereof. Examples of suitable benefit agents and adjuncts are generally described in U.S. Pat. Nos. 5,576,282; 5,858,948; and 6,121,226.

Any suitable brightener in any suitable amount can be used. For example, the “two-in-one” treating system and/or composition in one non-limiting embodiment can comprise a brightening agent which is deposited on leather and/or the midsoles of shoes via solution depletion of about 1% or greater without visible brightener staining. Suitable brightening agents include but are not limited to: coumarin derivative brighteners, oxazole brighteners, benzoxazolyl brighteners, and mixtures thereof.

Any suitable thickener and/or silicone wetting agent in any suitable amount can be used. For example, a suitable thickener may be UCAR® 106HE (25% active) from Dow Chemical. A suitable silicone wetting agent may be SILWET® L-7500, available from OSI Specialties. A suitable antifoam agent may be DCFB50® Plus (50% active) from Dow Corning.

The “two-in-one” treating systems may also comprise any suitable pre- and/or post-treating composition in any suitable amount or form. For example, suitable pre- and/or post-treating compositions may include, but not be limited to: soil release agents, film-forming polymers, waterproofing agents, leather, fabric or plastic treatment agents, antimicrobial agents, shine enhancing ingredients, ingredients designed to improve the appearance of painted exterior of athletic shoe leather, and mixtures thereof. A pre- and/or post-wash treatment can also be used on used, new, and/or clean shoes.

The “two-in-one” treating compositions may be formulated so that any damage to natural leather-containing surfaces of the one or more shoes is reduced when washing the one or more shoes in an aqueous medium containing the “two-in-one” treating composition in comparison to washing the one or more shoes in an aqueous medium free of the “two-in-one” treating composition and/or optional, one or more additional benefit agent.

The “two-in-one” treating systems and/or compositions may be essentially free of any material that would tend to soil or stain the shoes (e.g. chromium-binding agents). For example, in one non-limiting embodiment, the “two-in-one” treating systems and/or compositions may comprise no more than about 30%, no more than about 20%, no more than 10% by weight of the composition of chromium-binding agents that are capable of binding Cr³⁺ with a log K binding constant of more than about 12, more than about 9, or alternatively more than about 6.

In other non-limiting embodiments, the “two-in-one” treating systems and/or compositions may be essentially free of polyphosphates. In other words, the “two-in-one” treating systems and/or compositions may comprise less than about 5%, less than about 4%, less than about 3%, less than about 2%, less than about 1%, or alternatively about 0% by weight of the composition of a polyphosphate.

Any suitable bleach in any suitable amount may be used. For example, the “two-in-one” treating systems and/or compositions may comprise a peroxygen bleach, a chlorine bleach, and mixtures thereof, in an amount less than about 10% by weight of the composition. In one non-limiting embodiment, low levels of bleaching systems or bleaching agents are provided such that would neither damage the leather-containing shoes nor negate the treatment benefit(s) provided. In other words, when treating leather-containing shoes the “two-in-one” treating systems and/or compositions comprise less than about 5%, or less than about 2.5%, or less than about 1%, or less than about 0.5%, or less than about 0.1%, or alternatively 0% by weight of the composition of a bleaching system or agent, the desired benefit is provided without damage to the one or more shoes. Thus, in some non-limiting embodiments, the “two-in-one” treating systems and/or compositions may be essentially free of bleaching systems or bleaching agents, especially chlorine bleach, for example, when treating leather-containing shoes.

The “two-in-one” treating compositions can be prepared via any suitable process that is available to the formulator. Non-limiting examples of suitable processes and applications may be described in U.S. Pat. No. 5,691,297; U.S. Pat. No. 5,574,005; U.S. Pat. No. 5,569,645; U.S. Pat. No. 5,565,422; U.S. Pat. No. 5,516,448; U.S. Pat. No. 5,489,392; U.S. Pat. No. 5,486,303; and U.S. Pat. Appl. No. US20030069157A1.

In addition to the above examples, the “two-in-one” treating compositions can also be formulated into any suitable laundry detergent composition. Non-limiting examples of laundry detergents into which the “two-in-one” treating systems and/or compositions can be incorporated may include those described in U.S. Pat. No. 5,679,630; U.S. Pat. No. 5,565,145; U.S. Pat. No. 5,478,489; U.S. Pat. No. 5,470,507; U.S. Pat. No. 5,466,802; U.S. Pat. No. 5,460,752; U.S. Pat. No. 5,458,810; U.S. Pat. No. 5,458,809; and U.S. Pat. No. 5,288,431.

pH

Without being bound by theory, higher pHs tend to enhance cleaning performance. However, since those same high pHs may cause excessive damage to the shoes, especially leather-containing shoes, the pH or pH ranges should be chosen such that cleaning performance is optimized without excessive damage to the shoes. The “two-in-one” treating system and/or composition herein may have a pH, as determined in a 10% aqueous solution of the cleaning composition, in the range of from about 5 to about 11, from about 6 to about 10.5, or alternatively from about 7 to about 10. In one non-limiting embodiment where control of foot odor is desired, an alkaline pH modifier may be chosen to maintain the wash solution pH in the range of from about 7.5 to about 11, or alternatively from about 8 to about 10.

Methods for Treating Shoes

The “two-in-one” treating systems and/or compositions may be particularly suitable for use in the methods of the present invention; namely, methods for treating shoes in need of treatment. The “two-in-one” treating systems and/or compositions when applied to the wash and/or rinse water, and/or to one or more shoes surfaces in need of treatment may impart one or more desired benefits to the one or more shoes, such that the appearance of the desired benefits may endure multiple washings.

In one non-limiting embodiment, a method for treating one or more shoes in the wash and/or rinse water of an automatic washing machine is provided. An effective amount of the “two-in-one” treating composition may be applied directly to the wash and/or rinse water as a “through-the-wash” composition in order to impart one or more desired benefits to the one or more shoes. An effective amount of the HMPAP may be incorporated into a suitable laundry detergent and/or laundry rinse or softening product and dispensed according to the automatic washing machine manufacturer's recommendations.

In one non-limiting embodiment, a method for treating one or more shoes having an interior and an exterior surface is provided. The “two-in-one” treating composition may also be applied directly to the exterior surfaces of the shoes, to the interior surfaces of the shoes and/or both, by using an applicator, as defined in more detail herein. Rubbing of the “two-in-one” treating system and/or composition onto the surfaces of the shoe may expedite treatment of the surfaces of the shoe.

In one non-limiting embodiment, a “two-in-one” treating composition is provided in the form of a soft gel that is directly applied to the inside and/or outside of the shoe. It may be desirable that the “two-in-one” treating composition be distributed equally to all surfaces (both internal and external) of the shoe(s) being treated in order to provide even conditioning and cleaning benefits. For example, by holding onto the shoe and gently rocking the shoe from the toe to the heel of the shoe, the inside surfaces of the shoe may be evenly treated. The “two-in-one” treating composition may then be applied externally, with optional scrubbing as needed, to the outside surfaces of the shoes with an applicator. A standard hand brush or a powered brush may be used to improve cleaning on the exterior surface of the shoe(s).

For tough stains on heavily soiled shoes, multiple applications of the “two-in-one” treating composition and re-submersions may be necessary. If treatment of one or more shoes consists of several aqueous washing steps (that is, the water from a first treating cycle is removed after a first treatment and is then followed by additional treating and/or rinsing steps), it has been surprisingly found that the best cleaning and conditioning of the shoes occurs if the “two-in-one” treating composition is added during that first cycle of the wash, as opposed to the second or later cycles. Moreover, the best cleaning and conditioning of the interior surface occurs if the “two-in-one” treating composition can be added directly into the interior of the shoe.

On the other hand, the “two-in-one” treating composition may be effectively applied to one or more shoes in need of treatment indirectly, such as by the addition of an effective amount of the “two-in-one” treating composition to a suitable aqueous medium. For example, the “two-in-one” treating composition can be added to the aqueous medium before the wash, during the wash, or at any time, by hand or with the assistance of an automated dosing device. Agitation of the aqueous medium in an automatic washing machine containing the shoes to be treated facilitates and expedites cleaning and conditioning by permitting the “two-in-one” treating composition to diffuse onto and inside the shoe surfaces. A thorough rinsing of the one or more shoe surfaces after washing is desirable.

The “two-in-one” treating composition may be used as a pre-treat composition, a through-the-wash composition, and/or as a post-treat composition. In all of these cases, the “two-in-one” treating compositions may be formulated so that one or more of the desired benefits endure the washing and rinsing processes. Additionally, and alternatively, one or more other pre-treat compositions may be applied to the shoes prior to washing the shoes, and/or one or more post treatment compositions may be applied to the shoes after washing.

The “two-in-one” treating compositions can also be applied to “new” shoes (i.e., new and/or little worn or little soiled shoes) for preventative and/or comfort reasons. For example, a consumer may desire to treat such “new” shoes with a “two-in-one” treating system and/or composition comprising suitable benefit agents prior to wearing. For example, suitable benefit agents in this case can include, but are not limited to: additional conditioning agents, soil release agents, control agents, and mixtures thereof.

Without wishing to be bound by theory, it is believed that higher wash temperatures enhance cleaning performance. However, higher temperatures may cause excessive damage to the shoes during treatment, especially leather-containing shoes. Chromium can be extracted from leather to a greater extent at higher temperatures, and as a result, damage to shoes increases as temperature of wash solutions increase. Thus, a temperature or temperature range can be chosen such that cleaning and conditioning performance is optimized without excessive damage to the shoes. One non-limiting embodiment of a method for treating shoes in need of treatment comprises contacting the shoes with a “two-in-one” treating system and/or composition and subsequently washing the shoes in an aqueous medium having a temperature of no more than about 180° F. (82° C.), or no more than about 150° F. (66° C.), or alternatively no more than about 110° F. (43° C.). For example, the temperature of the aqueous wash medium may be in the range of from about 40° F. (5° C.) to about 175° F. (80° C.), or from about 50° F. (10° C.) to about 140° F. (60° C.), or alternatively from about 60° F. (15° C.) to about 100° F. (40° C.).

The “two-in-one” treating system may comprise a flexible container to protect the shoes and/or a washing machine, and to enhance shoe treatment during washing. Individual shoes may be placed in the flexible container for treatment; alternatively both shoes may be placed in the flexible container. The consumer may desire to deliver the “two-in-one” treating composition in or onto the flexible container and/or onto the one or more shoe or shoe surfaces before and/or after placing the shoes in the flexible container. The flexible container containing the shoe(s) may then be placed or submerged into a suitable aqueous medium for treatment of the one or more shoes. Proper selection of a flexible container can impact both the paint stability and/or cleaning effectiveness of the “two-in-one” treating compositions when used in conjunction with the treatment system and/or methods described herein. A suitable flexible container may comprise any suitable material, such as natural and/or synthetic fabrics that are resistant to tearing during agitation in an automatic washing machine. Suitable material include, but are not limited to acetate, acrylic, cotton, nylon, olefin, polyester, polypropylene, rayon, rubber, silk, spandex, triacetate, wool, and mixtures thereof.

In one non-limiting embodiment, a method for treating one or more shoes having an interior and an exterior surface comprising a “two-in-one” treating system comprising a “two-in-one” treating composition, optionally, one or more additional benefit agents, and a flexible container is provided. One or more treatments or applications of the “two-in-one” treating composition may be necessary in the flexible container, especially in the case of heavily soiled shoes. The method may comprise the steps of contacting a shoe or shoe surface in need of treatment with the “two-in-one” treating composition, placing the shoe in the flexible container, and submerging the shoe at least partially in an aqueous medium for an effective amount of time such that the “two-in-one” treating composition treats the shoe or shoe surface and provides one or more of the following desired benefits therein: cleaning, conditioning, softening, brightening, disinfecting, deodorizing, preserving, waterproofing, whitening, dying, or prolonging usage and comfort.

When applying the “two-in-one” treating composition, skin damage from exposure to the composition may be reduced by holding the shoe from the inside when applying the cleaning composition to the outside surface, and vice versa, or by placing the treated portion of the shoe partially in the flexible container during treatment of the remaining portions.

Ballast may be used in the washing machine and/or in the flexible container along with the one or more shoes in need of treatment to enhance cleaning and conditioning of the shoes during washing. Any suitable ballast may be used. In lieu of using another shoe to provide ballast, it is also possible to provide other suitable articles, such as towels, socks, rags, and the like. In some non-limiting embodiments, the flexible container can be eliminated from the process and some other article, such as a towel, could be provided to at least partially cover and protect the shoes during washing.

Product Form

The “two-in-one” treating compositions can be provided in any suitable form. Suitable forms include, but are not limited to, solids (powders, granules, bars, tablets, multi-phase tablets, or dimple tablets), liquids, pastes, gels, sprays, aerosols, sticks, foams, water soluble pouches, and combinations thereof. The “two-in-one” pre- and/or post-treatment compositions can also applied by any other practical means, such as by sprays, creams, foams, and aerosols, as well.

Granular “two-in-one” treating compositions can be in “compact form”, having a relatively higher density than conventional granular detergents (e.g. from 550 to 950 g/l). In such case, the granular “two-in-one” treating compositions may contain a lower amount of filler, such as an inorganic salt, as compared to conventional granular detergents. Typical filler salts may include but are not limited to alkaline earth metal salts of sulfates and chlorides. Typically sodium sulfate may be desirable. “Compact” detergents typically comprise no more than about 10% filler salt.

The “two-in-one” treating compositions in the form of liquids, gels and/or pastes can be “diluted” as in conventional liquid detergents, or they can be “concentrated,” such that a lower amount of water is used as compared to conventional liquid detergents. The water content of the concentrated “two-in-one” treating compositions may be less than or equal to about 50% by weight of the conventional “two-in-one” treating compositions.

While not wishing to be bound by theory, the performance of “two-in-one” treating compositions in gel, liquid and/or paste form can depend both viscosity and the dissolution rate or profile. The gel, liquid and/or paste forms should have a viscosity sufficiently high, such that it is easy to apply in bulk to the shoe. If the viscosity is too low, especially in the case where direct pre-treat of the shoes is employed, the majority of “two-in-one” treating composition may simply drain off the shoe as waste prior to washing. If this occurs, then the desired benefits from a pre-treatment may be substantially lost. If no pre-treat is desired and the treatment composition is added directly to wash water, a lower viscosity may be desired. On the other hand, if the viscosity is too high, the “two-in-one” treating composition may not be able to penetrate the fabric and/or leather portions of the shoe quickly enough to have the desired treatment benefit occur on those surfaces. In addition, many highly viscous solutions may be difficult to dissolve or quickly disperse. Poor or incomplete dissolution or dispersion of the “two-in-one” treating composition may be highly undesirable in some cases. For example, a residual of largely undissolved “two-in-one” treating composition on a shoe after treatment is aesthetically unpleasing to the consumer and may make the treated shoe uncomfortable to wear.

Articles of Manufacture

The articles of manufacture may include treating systems and/or compositions herein that may be suitable for use in the methods described herein. Articles of manufacture and/or devices may enhance the benefits imparted and facilitate treatment of the shoes by the “two-in-one” treating systems and/or compositions. Such articles or devices may be in the form of a kit and include, but are not limited to: a measuring cup or dispensing cup for unit dose applications; an applicator useful in directly applying the “two-in-one” treating composition to the shoes; a brush applicator for applying the “two-in-one” treating composition to heavily soiled shoes; a pre-treatment composition; a through-the-wash composition; a post-treatment composition; an additional benefit agent, and/or a detergent adjunct.

The “two-in-one” treating composition may be packaged in any suitable package. For example, the “two-in-one” treating compositions may be packaged in a pliable container fitted with an applicator cap. Suitable containers include those that permit application directly onto soiled shoe surface by squeezing, pouring, and/or spraying the “two-in-one” treating systems and/or compositions through the applicator cap. Such containers include those described in U.S. Pat. No. 4,107,067. Other applicators that may be used are described in WO 97/49614, GB 2180445, WO 85/05344, CH 602 193, DE 2428780, EP 875 465, WO 95/15710, WO 95/01121, GB 2187945, EP 380 182, EP 374 339, GB 2219769, WO 87/06112, FR 2688397 and U.S. Pat. Nos. 4,053,242, 5,568,990, 5,324,127, 5,020,930 and 5,418,996.

Any suitable flexible container made from any suitable material in any suitable size, shape, or form may be used. Suitable flexible containers for use herein can be provided in any number of configurations, and may be in the form of a flexible pouch or “protective bag”, which has sufficient volume to contain the one or more shoes to be treated. The flexible container can be of any convenient size, and should be sufficiently large to allow movement of the container and shoe(s) contained therein, such as during agitation by hand and/or by a mechanical agitator in a conventional automatic washing machine, but should not be so large as to interfere with the operation of the mechanical agitator. Suitable containers may be manufactured from any economical material. Some non-limiting examples include woven and non-woven fabrics, such as polyester, polypropylene, and the like, with the proviso that it must not tear during agitation, either by hand or by a mechanical agitator.

The “two-in-one” treating composition may also be added to the flexible container prior to and/or after placing the one or more shoes into the flexible container. The flexible container may be fully impregnated with the “two-in-one” treating composition, or coated (or partially coated) with a releasable coating of the “two-in-one” treating composition, such as, on the interior surfaces of the flexible container, to improve delivery of the “two-in-one” treating composition to the one or more shoes during washing.

The “two-in-one” treating systems and/or compositions may also be delivered to a shoe or alternatively to an aqueous medium by using one or more of the following products forms which incorporate an effective amount of the “two-in-one” treating composition: coated and/or impregnated fabrics (such as, woven non-woven sheets, and wipes), water-soluble pouches (including multi-compartment pouches), tablets (including dimple and/or multi-phase tablets), and combinations thereof. The pouches and tablets can also be used in pre- and/or post-treatment procedures as well.

The “two-in-one” treating systems and/or compositions may also be incorporated into a spray dispenser to create an article of manufacture that can facilitate treatment of shoes at a level that is effective, yet is not discernible when dried on the shoes. The spray dispenser may comprise manually activated and non-manual powered (operated) spray means and a container containing the “two-in-one” treating composition to be dispensed from a sprayer. The HMPAP may be dispensed from the container at a level of from about 0.01% to about 99%, from about 0.01% to about 70%, from about 0.01% to about 50%, from about 0.01% to about 20%, from about 0.05% to about 10%, from about 0.1% to about 10%, from about 0.1% to about 5%, or alternatively from about 0.1% to about 1%, by weight of the “two-in-one” treating composition.

Product Instructions

The present invention also encompasses the inclusion of instructions on the use of the “two-in-one” shoe treatment product comprising the “two-in-one” treating systems and/or compositions. The instructions may be included on or with the packages containing the “two-in-one” treating systems and/or compositions herein or with other forms of advertising associated with the sale or use of the “two-in-one” shoe treatment product, treating systems and/or compositions, alone or in combination. The instructions may be included in any manner typically used by consumer product manufacturing or supply companies. Examples include, but are not limited to: providing instructions on a label attached to the container holding the composition; on a sheet either attached to the container or accompanying it when purchased; and in advertisements, demonstrations, and/or other written or oral instructions which may be connected to the purchase of the “two-in-one” treating systems and/or compositions.

The instructions, for instance, may include information relating to the temperature of the wash water, such as, to use a temperature of no more than about 180° F. (82° C.), or no more than about 150° F. (66° C.), or alternatively, no more than about 110° F. (43° C.); washing time; recommended settings on the washing machine; recommended amount of the “two-in-one” treating system and/or composition to use; pre-treatment procedures; pre-soaking procedures; post-treatment procedures; and spray-treatment procedures. Under typical U.S. wash conditions in residential and/or consumer equipment, the recommended settings on the washing machine may be medium load, heavy duty, 12-14 minutes, warm wash, in the range of from about 40° F. (5° C.) to about 175° F. (80° C.), or from about 500 F (10° C.) to about 140° F. (60° C.), or alternatively, from about 600 F (15° C.) to about 1000 F (40° C.), with a cold rinse cycle. For wash conditions other than U.S. wash conditions, the recommended settings on the washing machine may be equivalent to the U.S. recommended settings. The instructions may also include directing that the consumer to set aside the treated shoes to allow them to air-dry and not be placed in a conventional automatic clothes dryer.

### EXAMPLES

| | EXAMPLES | | | | | | | | |
|---|---|---|---|---|---|---|---|---|---|
| | 1 | 2 | 3 | 4 | 5¹⁴ | 6¹⁵ | 7¹⁶ | 8 | 9 |
| Component | Wt % | Wt % | Wt % | Wt % | Wt % | Wt % | Wt % | Wt % | Wt % |
| HMPAP¹ | 7.50 | 7.50 | 7.50 | 7.50 | 10.80 | 10.80 | — | — | — |
| HMPAP² | — | — | — | — | — | — | 7.40 | — | — |
| HMPAP³ | — | — | — | — | 2.50 | 2.50 | — | — | — |
| HMPAP¹⁷ | — | — | — | — | — | — | — | 21.43 | 18.75 |
| Anionic | 10.00 | 10.00 | 8.00 | — | — | — | — | — | — |
| Surfactant⁴ | | | | | | | | | |
| Nonionic | — | — | — | 5.00 | 13.6 | 13.6 | 26.10 | 5 | 5 |
| Surfactant⁵ | | | | | | | | | |
| Nonionic | — | — | 2.00 | — | — | — | — | — | — |
| Surfactant⁶ | | | | | | | | | |
| Silicone | — | — | — | — | 1.80 | 1.80 | — | — | — |
| Surface | | | | | | | | | |
| Tension | | | | | | | | | |
| Agent⁷ | | | | | | | | | |
| Antifoam | 0.16 | 0.16 | 0.16 | 0.13 | — | — | 0.09 | 0.13 | 0.13 |
| Agent⁸ | | | | | | | | | |
| Ethanol | 1.03 | 1.03 | 0.83 | — | — | — | — | — | — |
| Propanediol | 2.64 | 2.64 | 2.11 | — | — | — | — | — | — |
| 2,2,4- | 2.00 | — | — | — | — | — | — | — | — |
| Trimethy- | | | | | | | | | |
| 1,3- | | | | | | | | | |
| Pentanediol | | | | | | | | | |
| Thickener⁹ | — | 2.00 | 2.00 | 2.00 | — | — | — | 8 | 8 |
| Structurant¹⁰ | — | — | — | — | — | — | 3.00 | — | — |
| Guar | 1.00 | — | — | — | — | — | — | — | — |
| Proxel GXL | — | — | — | 0.015 | — | — | — | 0.02 | 0.02 |
| Dantoguard | — | — | — | 0.15 | — | — | — | 0.08 | 0.08 |
| Borax | 3.00 | — | — | — | — | — | — | — | — |
| Sodium | — | — | — | — | — | — | 10.90 | — | — |
| perborate | | | | | | | | | |
| monohydrate | | | | | | | | | |
| Na3citrate.2 | — | — | — | — | — | — | 14.40 | — | — |
| H2O | | | | | | | | | |
| NaHCO3 | — | — | — | 1.0 | — | — | 6.30 | 1.00 | 1.00 |
| Na2SO4 | 0.05 | 0.05 | 0.04 | — | — | — | — | — | — |
| NaOH (50%) | 2.00 | 0.50 | 0.50 | 1.00 | | — | — | 1.00 | 1.00 |
| Triacetin | — | — | — | — | — | — | 21.70 | — | — |
| EDDS¹¹ | — | — | — | — | — | — | 1.10 | — | — |
| Bleach | — | — | — | — | — | — | 7.60 | — | — |
| Activator¹² | | | | | | | | | |
| Protease | — | — | — | — | — | — | 0.87 | — | — |
| Cellulase | — | — | — | — | — | — | 0.17 | — | — |
| Fluorescent | — | — | — | — | — | — | 0.17 | — | — |
| Whitening | | | | | | | | | |
| Agent¹³ | | | | | | | | | |
| Perfume | 0.40 | 0.20 | 0.20 | 0.40 | — | 0.50 | 0.20 | 0.40 | 0.40 |
| Patent Blue | — | — | — | 0.002 | — | — | — | 0.2 | 0.2 |
| Liquitint | | | | | | | | | |
| Dye¹⁸ | | | | | | | | | |
| Water | 70.22 | 75.92 | 76.66 | 82.80 | — | — | — | 62.75 | 45.43 |
| Water and | — | — | — | — | 71.30 | 70.80 | — | — | 20.00 |
| pH adjusters | | | | | | | | | |
| TOTAL | 100 | 100 | 100 | 100 | 100 | 100 | 100 | 100 | 100 |

¹A suitable hydrophobically modified polyacrylic copolymer is commercially available under the tradename ALCOSPERSE ® 725 (35% active) from Alco Chemical.
²Another suitable hydrophobically modified polyacrylic copolymer is commercially available under the tradename ALCOSPERSE ® 747-D (powder) from Alco Chemical.
³Another suitable hydrophobically modified polyacrylic copolymer is commercially available under the tradename LUBRITAN ® AS from Rohm and Haas Company.
⁴A suitable anionic surfactant is an ethoxylated alkyl sulphate, with alkyl chain length averaging from 12 to 15 carbons and having an average of 1.1 ethoxylate units.
⁵Another suitable nonionic surfactant is commercially available under the tradename NEODOL ® 23-9 from Shell Chemical Company.
⁶Another suitable nonionic surfactant is an alkyl glycoside produced by Cognis Corp. under the trade name GLUCOPON ® (50% active).
⁷A representative silicone wetting agent is SILWET ® L-7500, available from OSI Specialties.
⁸A suitable Antifoam is DCFB50 ® Plus (50% active) from Dow Corning.
⁹A suitable thickener is UCAR ® 106HE (25% active) from Dow Chemical.
¹⁰Na2SO4/sodium linear alkylbenzenesulfonate (described in PCT Publication WO 9942206 A1).
¹¹ethylenediaminedisuccinate, trisodium salt.
¹²N-nonanoyl-6-aminoheaxanoyloxybenzenesulfonate, Na + salt.
¹³A suitable brightener is known by the tradename of TINOPAL ® AMS-GX, and is available from Ciba Specialty Chemicals, Corp.
¹⁴Formulated at neutral pH.
¹⁵Formulated at neutral pH.
¹⁶Useful for treating canvas-containing shoes, this formulation comprises a substantially nonaqueous liquid detergent containing a nonionic surfactant, a peroxygen source, and optionally, a bleach activator. Alternatively, the shoes are wetted before the composition is applied to the shoes.
¹⁷A suitable hydrophobically modified polyacrylic copolymer is commercially available under the tradename ALCOSPERSE ® 747 (35-40% active) from Alco Chemical.
¹⁸Patent Blue Liquitint Dye as a 1% solution in water

Production

This product may be made by any suitable production process or means in any suitable order that is convenient to the manufacturer. Conventional continuous mixing or batch mixing techniques are those that are generally used. Frequently, batch mixing techniques are preferred because batch mix tanks are readily available and typically require less manufacturing controls.

Adding the thickener near the end of the production process can lower power requirements and facilitate dissolving and mixing of remaining ingredients, which are added to the batch before the thickener is introduced. In one non-limiting embodiment, the order of addition requires thickeners be placed into the batch at or near the end of the batch mixing process. Batch making can entail a sequential ingredient addition operation in a single batch tank, as well as, for the making of separate pre-mixes of ingredients, in any suitable order, that are subsequently added together. In another non-limiting embodiment, as provided in Example 8 above, the product is made by sequentially adding ingredients to a continuously stirred mix tank in the following order of addition: water, sodium bicarbonate, hydrophobically modified polyacrylic copolymer, antifoam, nonionic surfactant, proxel, danotgard, sodium hydroxide solution, perfume, dye solution, and then thickener. In another non-limiting embodiment, as provided in Example 9 above, a premix of the alkaline/buffer materials is made by adding sodium bicarbonate and sodium hydroxide solution to 20 parts of water and mixing. This premix is then added to a separate mixture, which is constructed by mixing the following in the order of addition: water, hydrophobically modified polyacrylic copolymer, antifoam, nonionic surfactant, proxel, danotgard, perfume, dye solution, and then thickener.

Test Methods

Full-Scale Washer Testing Method

A sample shoe, which has not been previously washed, is placed in the test washer along with three ballast shoes. The shoes are placed in a protective shoe bag. The ballast shoe(s) is any shoe(s) having a similar weight and size to the sample shoe. Alternatively, the ballast shoe is the same shoe type as the sample shoe. The sample shoe and the ballast shoes are spaced equidistant from one another in the tub of the test washing machine such that one of the ballast shoes is located beneath the washing tub water discharge. The test washing machine is set for a medium load using the wash level selection dial. The agitation speed is set at heavy duty using the speed selection dial. The appropriate dose of detergent is used and the concentration determined. A medium wash load contains a water volume of about 64 liters. The agitation speed for heavy duty is about 180 arcs per minute (apm), wherein an arc is one partial turn of the agitator in a clockwise direction. The wash cycle includes a spin portion at about 640 rpm and a single rinse. The total time for the wash cycle from beginning of the washer fill to completion of the last spin is about 40 minutes, and includes the following:
1. water fill (about 5 minutes for 64 liters, 7-8 gpg grains per gallon hardness);
2. wash cycle (about 14 minutes with agitation in clockwise direction only at about 180 apm;
3. water draining (about 2 minutes);
4. spin cycle (about 2 minutes at about 640 rpm);
5. rinse water fill (about 5 minutes for 64 liters);
6. rinse cycle (about 4 minutes with agitation in clockwise direction only at about 180 apm);
7. water draining (about 2 minutes); and
8. spin cycle (about 6 minutes at about 640 rpm).

The water is standard public supplied water, without any detergent or surfactant additives, and at a water temperature of between about 20° C. and about 35° C. The sample shoe is washed for fifteen wash cycles at the above-specified conditions, with a dry cycle between each wash cycle. As used herein, the phrase “wash cycle” is intended to refer to the aggregate of the cycles 1 to 8 described above at the designated washer medium load conditions. As used herein, the phrase “dry cycle” is intended to refer to a cycle wherein the first sample shoe is dried using a heating apparatus, such as a hair dryer type apparatus. During the drying cycle, the shoe temperature is indicated to be a maximum of about 44° C. After completion of the fifteen wash and dry cycles, the sample shoe is analyzed by evaluating leather conditioning as described herein.

Leather Conditioning Evaluation Method

Conditioning of leather is measured or indicated by the stiffness of the leather. The durometer is a meter that is used to read the stiffness of the leather samples. An scale-A analog durometer (serial number 112895) from Shore® is used. Calibration of the durometer is performed prior to taking the readings using a Shore rubber test block (61.0 lbs).

A leather sample is provided and consists of small pieces (˜1.5″×2.75″ or 3.81 cm×6.99 cm) of leather cut from a leather shoe as needed. Alternately, technical testing with pre-cut swatches of an unwashed athletic shoe leather (˜1.5″×2.75″ or 3.81 cm×6.99 cm) are used. The leather samples, having a finished side and an unfinished side, are evaluated for stiffness using the calibrated durometer, descrdibed above, with an open holed foot. For improved consistency, an automatic operating stand is used (Instrom Model 902, with a hold time set at ten seconds) to hold the shoe in place.

Three measurements are made on each side of each leather sample; three on the finished side and three on the unfinished side, totaling six measurements per sample. The results are then averaged. Alternatively, the leather samples are read initially before treatment and then after the final treatment to create a difference in stiffness measurements. The results of the differences are then averaged.

Small-Scale Mini-Washer Testing Method

A small-scale mini-washer is used to wash pre-cut swatches of an unwashed athletic shoe leather, as described in the leather conditioning evaluation method. Initially, six unwashed leather samples and an appropriate dose of detergent are placed in the 7.6-liter mini-washer. The appropriate detergent dose concentration is determined by matching the concentration used in a full-scale washer operation. The mini-washer is run under the following technical test conditions:

| | |
|---|---|
| Initial water fill and temp | (2 gallon or 7.6 L) fill, 8 gpg, 32.2° C. |
| First agitation | 14 minutes, 100% agitation |
| First spin | 2 minutes |
| Second fill | (2 gallon or 7.6 L) fill, 32.2° C. |
| Second agitation | 2 minutes |
| Second spin | 2 minutes |
| Third spin (finished side of | 2 minutes |
| leather to center) | |

Between each washing, the leather samples are completely dried in a constant temperature room set at 21.2° C. and 65% relative humidity. The wash/dry cycle is repeated a total of five times using an appropriate amount of detergent product, when appropriate. After completion of five wash and dry cycles, the leather samples are analyzed by evaluating leather conditioning as described herein.

Test Results

In accordance with the small-scale mini-washer testing method described above, six leather samples are washed using the “two-in-one” treating composition of formulation Example 4 gel and evaluated against treatment using water alone, and/or treatment using a commonly available laundry detergent powder dissolved in wash water over five wash/dry cycles. The final durometer reading is compared to the initial durometer reading, and differences in the two measurements (e.g. final—initial readings) are calculated. Higher average differences indicate negative conditioning or a stiffening of the leather material. Lower average differences indicate less leather stiffening or superior leather conditioning.

TABLE 1

| | Effective | Average difference in |
|---|---|---|
| | Concentration of | durometer readings |
| | Detergent | (final − initial) on six |
| Treatment Product | In Wash Water | leather swatches |
| Water only | N/A | 7.7 |
| Laundry Detergent | 3.25 gm/gal | 7.8 |
| Powder¹ | (12.30 gm/l) | |
| Example 4 Gel | 7.05 gm/gal | 5.5 |
| | (26.69 gm/l) | |

¹Laundry detergent powder is commercially available under the tradename SURF ® from the Unilever Company.

The data in Table 1 shows that treatment of six leather samples with the formulation of Example 4 gel provides superior leather conditioning (having less stiffness) as compared to treatment with water alone, and/or treatment with a commonly available laundry detergent powder, when washed and dried over the five wash/dry cycles.

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

It should be understood that every maximum numerical limitation given throughout this specification would include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

While particular embodiments of the subject invention have been described, it will be obvious to those skilled in the art that various changes and modifications of the subject invention can be made without departing from the spirit and scope of the invention.

It will be clear to those skilled in the art that various changes and modifications may be made without departing from the scope of the invention and the invention is not to be considered limited to the embodiments and examples that are described in the specification.

1. A “two-in-one” treating composition for cleaning and conditioning shoes comprising:
a) a hydrophobically modified polyacrylic acid; and
b) optionally, one or more additional benefit agents.

2. The two-in-one treating composition of claim 1 comprising from about 0.001% to about 90% of said hydrophobically modified polyacrylic acid.

3. The two-in-one treating composition of claim 1 comprising an effective amount of said one or more additional benefit agents selected from the group consisting of: soil release/removal agents, surfactants, calcium/magnesium removal agents, pH modifiers, heavy metal chelating agents, suds suppressors, chemical stabilizers including antioxidants, silicones, antimicrobial actives, preservatives, bleaches, bleach activators, bleach catalysts, enzymes, enzyme stabilizing systems, hydrotropes, opacifiers, antioxidants, brighteners, perfumes, dyes, carriers, speckles, and mixtures thereof.

4. The two-in-one treating composition of claim 3 wherein said one or more additional benefit agents comprise said one or more surfactants selected from the group consisting of: anionic, nonionic, cationic, zwitterionic, and amphophilic surfactants, and mixtures thereof.

5. The two-in-one treating composition of claim 4, wherein said one or more surfactants comprise from about 1% to about 80% by weight of the composition of a nonionic surfactant.

6. The two-in-one treating composition of claim 5, wherein at least some of said nonionic surfactant comprises an C₈-C₁₈ alkyl ethoxylate, with an average degree of ethoxylation from about 5 to about 15 moles of ethylene oxide per mole of alcohol.

7. The two-in-one treating composition of claim 1 having a pH, as determined in a 10% aqueous solution of the treating composition, in the range of from about 5 to about 11.

8. A two-in-one treating system for treating one or more shoes, said system comprising:
a) a two-in-one treating composition comprising:
(i) a hydrophobically modified polyacrylic acid; and
(ii) optionally, one or more additional benefit agents; and
b) a flexible container.

9. The two-in-one treating system of claim 8 comprising from about 0.001% to about 90% of said hydrophobically modified polyacrylic acid.

10. The two-in-one treating system of claim 8 comprising an effective amount of said one or more additional benefit agents selected from the group consisting of: soil release/removal agents, surfactants, calcium/magnesium removal agents, pH modifiers, heavy metal chelating agents, suds suppressors, chemical stabilizers including antioxidants, silicones, antimicrobial actives, preservatives, bleaches, bleach activators, bleach catalysts, enzymes, enzyme stabilizing systems, hydrotropes, opacifiers, antioxidants, brighteners, perfumes, dyes, carriers, speckles, and mixtures thereof.

11. The two-in-one treating system of claim 8, wherein said flexible container comprises natural and/or synthetic fabrics that are resistant to tearing during agitation in an automatic washing machine.

12. The two-in-one treating system of claim 11, wherein said flexible container comprises a fabric selected from the group consisting of acetate, acrylic, cotton, nylon, olefin, polyester, polypropylene, rayon, rubber, silk, spandex, triacetate, wool, and mixtures thereof.

13. A method of treating one or more shoes having an interior and an exterior surface, said method comprising the steps of:
a) providing an effective amount of a two-in-one treating composition, comprising:
(i) a hydrophobically modified polyacrylic acid; and
(ii) optionally, one or more additional benefit agents; and
b) contacting one or more shoes in need of treatment with said two-in-one treating composition by submerging or at least partially submerging said one or more shoes in an aqueous medium for an effective amount of time so that said contact provides one or more of the following desired benefits to said one or more shoe surfaces: cleaning, conditioning, softening, brightening, disinfecting, and deodorizing.

14. The method according to claim 13 comprising from about 0.001% to about 90% of said hydrophobically modified polyacrylic acid.

15. The method according to claim 13 comprising an effective amount of said one or more additional benefit agents selected from the group consisting of: soil release/removal agents, surfactants, calcium/magnesium removal agents, pH modifiers, heavy metal chelating agents, suds suppressors, chemical stabilizers including antioxidants, silicones, antimicrobial actives, preservatives, bleaches, bleach activators, bleach catalysts, enzymes, enzyme stabilizing systems, hydrotropes, opacifiers, antioxidants, brighteners, perfumes, dyes, carriers, speckles, and mixtures thereof.

16. The method according to claim 15, wherein said one or more additional benefit agents comprise cleaning agents comprising one or more surfactants selected from the group consisting of anionic, nonionic, cationic, zwitterionic, and amphophilic surfactants, and mixtures thereof.

17. The method according to claim 16, wherein said one or more surfactants comprise from about 1% to about 80% by weight of the composition of a nonionic surfactant.

18. The method according to claim 13, wherein said treating composition has a pH, as determined in a 10% aqueous solution of the treating composition, in the range of from about 5 to about 11.

19. A method according to claim 13, wherein said aqueous medium is selected from the group consisting of wash water, rinse water, sink water, hose water, rain, river or lake water, and combinations thereof.

20. A method according to claim 19, wherein said aqueous medium is the wash and/or rinse water in an automatic washing machine.

21. A method according to claim 13, where said method further comprises one or more of the following steps:
a) pre-treating said one or more shoes with an effective amount of a pre-treatment composition;
b) placing said one or more shoes in said flexible container prior to contacting said one or more shoes with said two-in-one treating composition in an aqueous medium;
c) placing said one or more shoes in said flexible container prior to partially submerging said one or more shoes in an aqueous medium; and
d) post-treating said one or more shoes with an effective amount of a post-treatment composition.

22. A method according to claim 13, wherein when said one or more shoes comprise canvas or mesh surfaces, wherein said two-in-one treating composition comprises at least one benefit agent comprising one or more of the following: a nonionic surfactant, a peroxygen source, a bleach activator, and conventional detergent adjuncts; and wherein said two-in-one treating composition is liquid and is substantially nonaqueous.

23. A method according to claim 13, wherein the form of said two-in-one treating composition is selected from the group consisting of powders, granules, bars, tablets, multi-phase tablets, dimple tablets, water-soluble pouches, water-soluble multi-compartment pouches, liquids, pastes, gels, sprays, aerosols, sticks, foams, and combinations thereof.

24. An article of manufacture for providing cleaning and conditioning benefits to one or more shoes having an interior and an exterior surface, said article comprising a kit comprising:
a) a two-in-one treating composition comprising:
i) from about 0.001% to about 90% of said hydrophobically modified polyacrylic acid; and
ii) optionally, one or more additional benefit agents; and
b) a flexible container comprising natural and/or synthetic fabrics that are resistant to tearing during agitation in an automatic washing machine;
wherein said kit comprises a package comprising instructions for using said two-in-one treating composition and/or said flexible container to treat said one or more shoes.

25. A composition of matter comprising wash and/or rinse water in an automatic washing machine, wherein said wash and/or rinse water comprises from about 2 ppm to about 10,000 ppm, by concentration, of a hydrophobically modified polyacrylic acid, and optionally, one or more additional benefit agents, delivered via an automatic washing detergent composition.
